(19) United States
(12) Patent Application Publication
(10) Pub. No.: US 2011/0103713 A1
(43) Pub. Date: May 5, 2011

(54) WORD LENGTH INDEXED DICTIONARY FOR USE IN AN OPTICAL CHARACTER RECOGNITION (OCR) SYSTEM

(76) Inventors: Hans Christian Meyer, Oslo (NO); Fosseide Knut Tharald, Kolbotn (NO)

(21) Appl. No.: 12/922,308

(22) PCT Filed: Mar. 10, 2009
(86) PCT No.: PCT/NO2009/000087

§ 371 Date: Jan. 6, 2011

(30) Foreign Application Priority Data
Mar. 12, 2008 (NO) 2008 1318

(51) Int. Cl. G06K 7/10

(52) U.S. Cl. 382/321

(57) ABSTRACT

A method for organizing a dictionary look up process in an Optical Character Recognition (OCR) system is described. Word length and an additional relative position within the words of a graphical feature, for example a stem, ascender, descender etc. are used in combination to index a dictionary. Unrecognized characters are analysed the same way, i.e. word length and relative position within the unrecognized word is then used to address the dictionary, resulting in an output of one ore more candidate words as an identification of the unrecognized word. An iterative process may reduce the number of candidate words identified in the dictionary look up process.

The present invention is related to the field of Optical Character Recognition (OCR) systems, and especially to a method for recognizing words in an images of a text document by identifying word lengths and at least one geometrical feature of a character within each respective word, according to the attached independent claim 1, and preferred embodiments are defined in the attached dependent claims 2 to 10.

Optical character recognition systems provide a transformation of pixelized images of documents into ASCII coded text which facilitates searching, substitution, reformatting of documents etc. in a computer system. An example of use of OCR functionality is to convert handwritten and/or typewriter typed documents, books, medical journals, etc. into for example Internet or Intranet searchable documents. Generally, the quality of information retrieval and document searching is considerably enhanced if all documents are electronically retrievable and searchable. For example, a company Intranet system can link together all old and new documents of an enterprise through extensive use of OCR functionality implemented as a part of the Intranet (or as part of the Internet if the documents are of public interest).

However, the quality of the OCR functionality is limited due to the fact that the complexity of an OCR system is enormous. It is difficult to provide an OCR functionality that can solve any problem encountered when trying to convert images of text into computer coded text. Prior art comprises numerous examples of mathematical methods, pattern recognition algorithms etc. that tries to solve the OCR problem. However, many proposals are difficult to implement in a computer environment due to processing speed limitations, or the conversion of text (for example by scanning) to computer readable image formats may impose errors or masks details of characters and words. One of the common solutions to the OCR problem comprises using a dictionary look up table, wherein for example images of characters (words) are related (or linked) to a corresponding index (or reference) which then is used to address a table (dictionary) comprising words, and wherein the word that is returned from the table (dictionary) is for example an ASCII coded character string of the word, which then represents the identification of this particular word. However, this simple plan has difficulties to achieve a high recognition rate due to many reasons as known to a person skilled in the art. For examples, difficulties with the mapping of images to dictionary addresses. It is also usually difficult to segment words and characters in the image of the text.

In prior art there are some examples of using the above outlined scheme. For example, U.S. Pat. No. 7,062,089 B2 discloses a system comprising a computer pad input device transferring images of handwritten text into the recognition system. The main task of this invention is to identify blank characters between words thereby enabling an identification of each respective word through identifying when the writing makes a stop (inserting a blank character) and/or when the writing starts which is after a blank has been inserted. This provides a possibility to investigate handwritten words in a further OCR processing, for example comprising a dictionary look up process.

Another example of identifying blank characters, for thereby identifying words, is disclosed in the Japanese patent publication No. 03137275. The teaching of this publication comprises using word statistics, for example word statistics of the English language, providing a word length distribution which is used to identify possible blank characters and words.

However, these prior art techniques do not address the problem of actually identifying the images of unknown words, only how to group/separate words from each other in the image of the text. Word length statistics of any language indicates that some words of a particular length are rarer than other words. However, the main purpose of observing word length is that the word length divides words into subgroups according to the word length, and any unrecognized word with a particular word length is probably among the candidate words constituted by the subgroup with the same word length. For some words the subgroup comprises few words, for others the subgroup comprises many words. However, on average, this scheme narrows the number of possible candidate words as identification solely on basis of the word length itself. By providing a limited number of candidate words, the identification process as such is considerably simplified, as known to a person skilled in the art.

According to an aspect of the present invention, word length in itself can be used to index a look up dictionary. According to an example of embodiment of the present invention a dictionary is indexed according to a measure of word length for a particular word together with a relative measure of a position within the same word of at least one graphical feature of a character, for example a stem rising above other characters in the word. The word length together with this at least one relative position is used to index a dictionary. When an unrecognized word is characterized the same way, that is, a measure of word length and a measure of relative position of at least one particular graphical feature within the word is provided for, these parameters can then be used to address the indexed dictionary providing output of one ore more candidate words from the dictionary as candidates for a possible identification (for example as ASCII coded text strings) of the unrecognized word. According to another example of embodiment of the present invention, if the number of candidate words in a subgroup for a particular unrecognized word is above a preset threshold level, the process is performed once more, wherein the dictionary is indexed according to the word length in addition to at least two or more measures of relative position for at least two or more graphical appearances within the word. In this manner, the number of candidate words identified through the dictionary look up process for a particular unrecognized word will provide as output form the dictionary a very limited number of candidate words, in many instances only one candidate word, which then facilitates the identification of unrecognized words considerably. If there is more than one candidate word for an unrecognized word in a subgroup, the remaining candidate words representing the same unrecognized word can be sorted out and eventually be explicitly identified by other OCR means as known to a person skilled in the art. However, the number of words that has to be processed by these other OCR means are considerably limited by the dictionary look up process according to the present invention, which makes the OCR system as such much more efficient in solving its task. According to yet another aspect of the present invention, the dictionary look up process according to the present invention may provide a partial recognition of words, or just a certain identification of a character or a plurality of characters within words. This aspect enhances the performance of the OCR system, for example in the further OCR processing as described above.

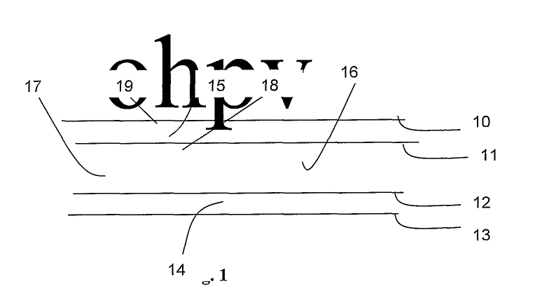

FIG. 1 illustrates how images of characters can be described by graphical shape components according to prior art.

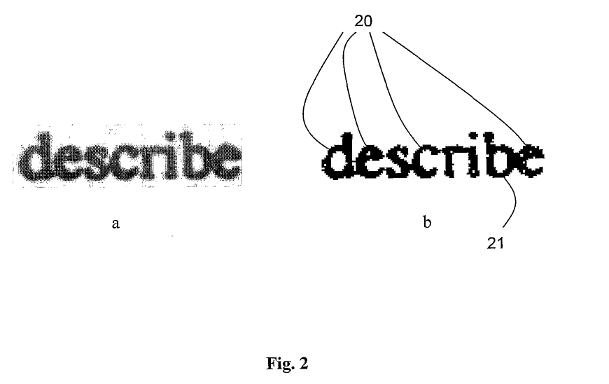

FIG. 2a illustrates a grey level coded image of a word.

FIG. 2b illustrates a conversion of the image in FIG. 2a to a bitmap coded image.

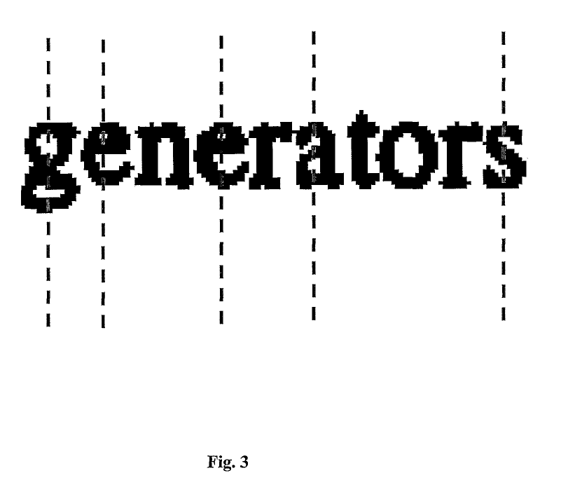

FIG. 3 illustrates an example of identifying positions of a certain graphical aspect of the word within the word itself according to the present invention.

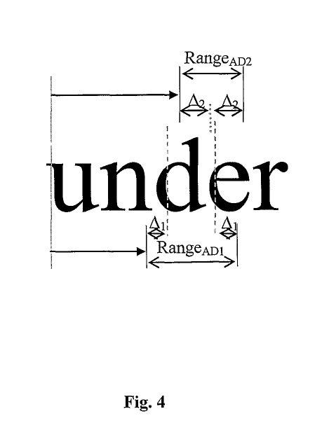

FIG. 4 illustrates tolerance parameters related to relative position of geometrical features within a word according to the present invention

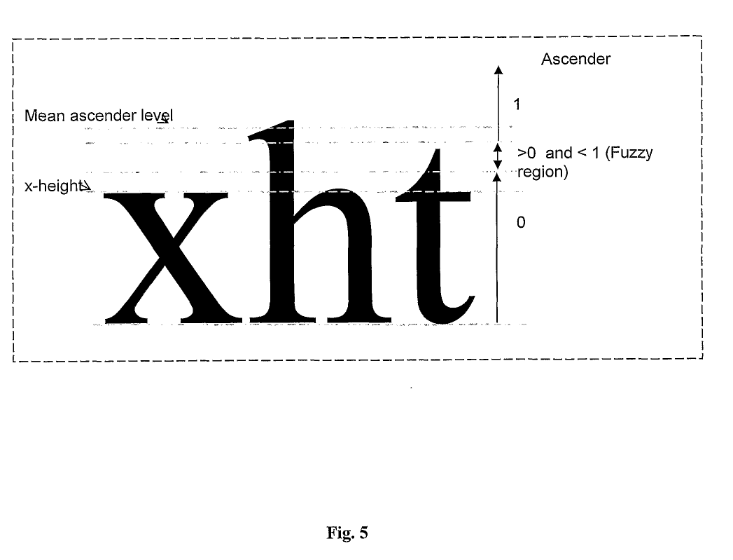

FIG. 5 illustrates tolerance parameters related to ascender/descended calculations within a word according to the present invention

The present invention utilizes graphical features of characters and respective word length as part of a dictionary look up process in an Optical Character Recognition (OCR) system, for example implemented in a computer system. A measure of word length can for example be the number of pixels used for the word in a computer coded image of a text comprising the word. If the OCR system provides proper character segmentation, the word length can be the number of characters in the word. Word length can also be assigned as a relative fraction of a complete text line in the document, for example, calculated from a measurement of a distance between two consecutive blank characters being identified in the document on a same text line. The content between blank characters is by definition a word. Other methods may use properties related to connected pixels to identify spaces between words and characters, and thereby word lengths directly or indirectly.

Graphical features of characters constituting a word can for example be a stem, a bow, an arch etc. However, to provide a consistent description of characters based only on shape is difficult. FIG. 1 illustrates an example of describing fonts based on shape components as found in the article “Parameterizable Fonts Based on Shape Components” by Changyan Hu and Roger D. Hersch published in IEEE Computer Graphics and Applications, May/June 2001. This prior art teaching provides a consistent scheme of describing any type of font based on shape components. With reference to FIG. 1, a word is analysed by introducing horizontal lines or staff lines parallel with the text line direction of the word. The text line is also often referred to as the base line 12. Line 13 is referred to as the descender line identifying the lowest end position of for example a descender stem 14 of a character. Line 10 is referred to as the ascender line which indicates the upper end position of an ascender stem 15. The x-height line 11 indicates the upper height of the character body. Other geometrical features can be the top serif 19 in the letter ‘h’, the arch 18 in the same letter, and the left bow 17 of the character ‘o’. The reference numeral 16 indicates a diagonal bar which further can be qualified as narrow or broad. As readily understood, the actual appearance of such shape components varies between different font types, for example the font times new roman is considerably different from the papyrus font. However, they both can be described by the shape component means outlined above. The differences in appearance between the fonts manifest itself in the connection or sequence of different shape components. Character design follow some rules to be readable and printable and therefore a limited number of geometrical features is usually enough to use in font design, and therefore it is possible to use a fixed number of different shape components to achieve a “descriptive language” in the form of shape components that can describe most font types with the same kind of generic shape components (i.e. stem, bow, arch, stem, serif etc.). The relative position of a graphical feature, for example a stem, can be qualified according to which side of a character body the graphical feature appears. For example, a stem can be a left descender, a middle descender or a right descender stem etc., which means that the stem descends on the left side of the character body, from the middle of the character body, or from the right side of the character body, respectively. Generally, the sequence or order the shape components are listed or described as connected can reflect the order of describing the shape components in an image of the character starting for example from a left bottom corner and then in the direction of the clock.

It is important to understand that the descriptive means provided for by using shape components are independent of coding schemes for images in a computer system. These shape components are generic terms. However, the identification of such shape components may be provided for on a pixel level and/or bitmap level in an image of a document. An example of describing shapes on a pixel level is to analyse connected pixels. The shape provided for by a set of connected pixels can then be analysed, identified and compared with a generic shape description. In this manner it is possible to identify stems, bows etc. as known to a person skilled in the art.

The identification of an unknown word according to an aspect of the present invention may then be achieved by the relationship between word length and positional information about a particular geometrical aspect or appearance within the word. The word length sorts or divides the dictionary words into subgroups comprising different number of words. However, all words within one subgroup have the same length. Such subgroups can then again be dived into further subgroups according to the positional information or measure that is selected. As can be understood, the division into further subgroups can vary dependent on the type of geometrical feature that is used. For example, one ascender stem can provide a different division compared to when using one descender stem. The result will be different if one descender stem and one ascender stem is used. It is also important to understand that the sequence of features that are used also have an impact on the number of words in the resulting subgroups. Therefore, according to yet another aspect of the present invention, minimizing the number of words in a particular subgroup may comprise a trial and error search, wherein different geometrical features are used, alone or in combinations, wherein the order the features are used is of importance.

A dictionary in a computer system comprises words that are usually coded with ASCII character strings. Such a dictionary or table can for example be stored in a section of a computer memory comprising consecutive addressable storage locations. Each storage location may contain an ASCII coded character string representing a word. A word in the table can then be referenced by mapping a word into for example a memory address of the corresponding location in the table comprising the ASCII coded character string representing the word. For example, the value of the ASCII code can be translated by different address mapping schemes to any memory address in a computer memory system as known to a person skilled in the art. According to an example of embodiment of the present invention, a dictionary may be organized as a set of linked lists, wherein each respective linked list represents and comprises all words in a dictionary having the same word length, i.e. there is a separate list for each word length. When referencing or addressing the dictionary with a particular word length, the linked list of words with this particular word length will be retrievable from the dictionary (via the addressing scheme that is used in the particular embodiment; for example, a table comprising all addresses of the ASCII coded dictionary described above, wherein each table reference is a word length), and thereby all words of the same identified word length. According to an aspect of the present invention, it is possible to combine the word length with other parameters, for example a measure of relative position of a graphical feature of a character within the word, for example the position of an ascender stems 15 of the word ‘ohpv’ in FIG. 1. The word length and the relative measure of position can be combined into one unique number being a reference to the linked list comprising all words in the dictionary having the same word length. When the word length and the relative measure of position is combined to a single number or identifier (and/or mapped according to an address mapping scheme), the dictionary can be sorted into linked lists wherein each respective list comprises the words of the same word length having the same shape component or graphical feature in the same position within the words. According to another example of embodiment, the dictionary is sorted into respective linked lists comprising words of same word length. The relative measure of position for a particular shape component or graphical feature is then used to search the words in the list with the same word length as the unrecognized word, and from this search a subgroup comprising candidate words with same word length and same relative position within the words for the same type of graphical feature will be obtained. The mapping from word length combined with a measure of relative position can be mapped according to a scheme as known to a person skilled in the art.

According to another example of embodiment of the present invention, tables are generated in stead of linked lists. The value of the word length can be translated into an address representing an entry into a first table. Each respective entry in the first table can then comprise all words of the dictionary having the same word length. When a shape component or graphical feature is selected, a second table can be created, wherein the address of the table is the relative position of the selected shape component within the words. On each address of the table corresponding words from the dictionary having the same relative position for the same selected shape component or graphical appearance is listed. According to an aspect of the present invention, tables for each respective shape component or graphical appearance can be generated in advance. When a specific combination of a specific word length and a specific shape component is selected, a combined third table can be generated as an intersection between the first table and second table, wherein the first table is addressed by the word length and the second address is addressed by the relative position of the selected shape component within the words. According to yet another example of embodiment of the present invention, the entries in the first table, second table and third table may be the addresses to the ASCII coded dictionary as described above for each respective word in the first, second and third table.

The number of member words in a linked list (or table) as described above is dependent on the number of graphical features that are used, how rare the word length is etc. Unrecognized words can then be analysed and characterised the same way the dictionary is ordered and sorted, the dictionary look up process according to the present invention will then enable an output of one candidate word or as few candidate words as a possible as an identification for the unrecognized word. When the dictionary is ordered only according to word length, this ordering or sorting needs only to be performed once according to the present word length calculations being performed. Combinations of word length and other parameters may require a dynamical ordering (sorting) and/or reordering dependent on status of the dictionary look up process.

The above described examples of indexing a dictionary may assume that it is possible to segment characters from the image of the document. thereby enabling an analysis of word length and relative position of features as discussed above. In some circumstances the quality of the document being processed may be poor. For example due to aging, fading ink imprints of characters, errors in a typewriter that was used to write the document, etc. may have impaired the image of the document being processed in the OCR system making it difficult to distinguish details. A conversion from a grey level coded image (with pixels) to a bitmap (black and white) image which is done in an OCR system may in itself leave errors in the bitmap image due to threshold level problems, as known to a person skilled in the art. FIG. 2a illustrates a grey level image while FIG. 2b illustrates the corresponding bitmap image. However, a measure of word length can be established, for example as a count of bits from the left most side of the word to the right most side of the word along the text line direction. As can be seen from FIG. 2b, a graphical feature 20, which is an upper left bow, is identifiable in the image, as well as a bottom bow 21. The relative position of such features 20, 21 can be the number of pixels from the left most side of the word until the centre point of the bow (which can be calculated as a centre of gravity of the connected pixels of the bow, for example). The type of graphical features that are selected as a distinguishing factor does not necessary have to be linked to particular shape components. For example, FIG. 3 illustrates that along each of the vertical dotted lines, each dotted line crosses three respectively horizontally oriented parts of the characters. Such crossings can be codes as an “on-off-on” pattern. The crossing can also be between horizontally oriented parts or slanted parts as well. Such distinguishing details are relatively insensible to poor image quality and accurate positioning of the feature.

To be able to compare word length and different relative positions of graphical features of characters inside unrecognized words, a corresponding analysis must be established for the content of the dictionary. A dictionary is language specific of course, but the method steps of the present invention is only related to graphical aspects of the words, not the spelling etc., and is therefore applicable to any language and corresponding language symbols.

In an example of embodiment of the present invention, wherein the words of the dictionary is coded as ASCII character strings, each respective ASCII character is linked to a linked list in a database comprising each shape component. The order of the members in the linked list illustrates the interconnection between the shape components. If a shape component simultaneously is linked to two succeeding shape components, these two components are located above each other in an image of the character. The order can signify which one is above the other. Since the listing only comprises generic shape components, the distance between these shape components are of no importance, i.e. the significance is related to for example a “bow above a horizontal bar”, which implies that these two shape components (bow and bar) are graphically connected to the previous shape component which is simultaneously being linked to these two s succeeding shape components. If these two succeeding shape components originate from a same point on the previous shape component, this can for example be indicated in the linking information element in the previous shape component in the list.

Documents can be printed with different font types wherein some font types or classes have substantially different graphical appearance. However, within some limits, a description based on shape components can be independent of font type as such since it is the shape components and their interconnections that provide a manifestation of the differences between the fonts or character classes. (A character class is a same letter, for example the letter ‘a’). However, in another example of embodiment of the present is invention, within the database records, each respective ASCII character is linked to equivalent linked lists for the same ASCII character, each equivalent list being related to font types. Therefore, if the OCR system recognize the font type, or the font type is an input to the system, the organization and sorting of the dictionary according to the present invention can take into account the font type. However, it is important to understand that the scheme outlined above is independent of actual size of characters in the image of the document. The shape components are generic terms, anyhow.

In another example of embodiment of the present invention, it is assumed that the actual graphical appearance of words and characters as they actually appear in a document provides more details that can be used to establish a more secure identification or grouping of words. Especially, if the dictionary look up process according to the present invention is being used on impaired images of text, the identification of a measure of word length and relative measure of a specific graphical feature must take into account the visual appearance of characters, words etc. as they actually appears in the document. Therefore, pixels are used in this example for establishing for example word length as a number of pixels, while the relative position of a graphical feature can the number of pixels from a left most start of the word, or a relative pixel number within the word, for the start of the graphical feature, or a centre of gravity of the pixels constituting the graphical appearance, or an analysis of connected pixels may provide a translation of connected pixels into generic shape components, etc.

In yet another example of embodiment of the present invention, wherein the words of the dictionary is coded as ASCII character strings, each ASCII character is linked to an image representing a graphical imprint of the character. Since characters can be embodiments of many types of different fonts and sizes an example of embodiment of the present invention links the respective ASCII characters to a database comprising all the different font types and sizes. If a size is missing, a scaling of a particular font family or class can be done as known to a person skilled in the art. In an example of embodiment of the present invention, an analysis of font type and size is performed, for example by identifying a set of some characters that can be segmented from the image of the document, and then compared with the images of the database described above comprising font types and sizes. In another example of embodiment, these parameters are passed from other functions in the overall OCR system the present invention is part of, or is a user input. When font type and size is identified, the dictionary can be organised as a set of linked lists indexed by the word length and in addition, as an alternative, the word length and at least a relative measure of position of a chosen graphical feature of a character, as discussed above and correctly expressed according to font type and size.

Another parameter that can influence word length is the character to character distance. This distance can be a function of font type, typewriter, layout, etc. This distance can for example be identified from the image of the text. Therefore, in an example of embodiment of the present invention, a measure of word length is defined as

$$W = {\sum }_{i = 1}^{n} w ( class ( {ch}_{i} ) ) + ( n - 1 ) δ$$

wherein class(chᵢ) is the character class for the character in position i of the word, w( . . . ) is the width of the character in the class and δ is the character-to-character distance within the words (and not between words). Ligatures should be treated as single special characters for this width calculation.

The relative measure of position of a graphical feature (shape component) within a word can be calculated in a similar way, by

$${AD}_{pos} = {\sum }_{i = 1}^{k} w ( class ( {ch}_{i} ) ) + ( k - 1 ) δ + {p}_{k}$$

where pₖ is the position (pixel position) of the graphical feature (for example an ascender or descender). The other parameters are as above. If the position pₖ is not known, the centre of the character can be used.

Sometimes it is necessary to distinguish positions between graphical features in a more precise manner. For example, a gliding bounding box can be established between the x-height line 11 and for example the ascender line 10 (ref. FIG. 1) above a word. By moving the gliding bounding box one character at a time, any graphical feature, such as an ascender can be identified. The bounding box may be only one pixel in width, wherein the movement then is a step of one pixel at a time. However, whenever two objects are compared, there may be necessary to allow a certain tolerance in the calculations of a position, for example by introducing a tolerance in the calculations. How the tolerance is used is dependent on whether for example the ascender or descender position within the character is known or not. This situation is also important to take into account when providing synthesized images of words from a dictionary, for example when using a specific font type and scaling to a certain text size. Tolerances should be introduced to account for variations that may appear in actual printing of text, for example. FIG. 4 illustrates the situation. The variables Δ₁ and Δ₂ as indicated in FIG. 4 details the respective variations in tolerance of a position for a graphical feature (shape component), and for the positioning of the character itself (which influence the word length, for example). In an example of embodiment Δ₁ varies from ¼ to ½ of a mean character width of the actual characters used in the image of the document, while Δ₂ varies from ½ to ¾ of the mean character width. If the detailed position is not known, the range (tolerance) for a word candidate with a shape component in character k is, according to an example of embodiment of the present invention:

$${range}_{AD 1} = 〈 \text{?} w ( class ( {ch}_{i} ) ) + max ( k - 1 , 0 ) δ - {Δ}_{1} , \text{?} w ( class ( {ch}_{i} ) ) + max ( k - 1 , 0 ) δ + {Δ}_{1} 〉$$

$$\text{?} \text{indicates text missing or illegible when filed}$$

If an estimate of the detailed position is known:

$${range}_{AD 2} = \text{?} w ( class ( {ch}_{i} ) ) + max ( k - 1 , 0 ) δ + {p}_{k} + 〈 - {Δ}_{2} , + {Δ}_{2} 〉$$

$$\text{?} \text{indicates text missing or illegible when filed}$$

It is preferred to choose the tolerance parameter Δ₂ greater than Δ₁.

Even though the ASCII coded dictionary can be transformed to images of characters as described above, different font types may have problems with respect to where staff lines can be positioned. FIG. 5 illustrates an example of fonts wherein the ascender line must be located as a “mean ascender line” since different characters do have different ascender height. Therefore, the comparison between unrecognized characters and images of words from the dictionary should be modified due to these considerations. There will be a sort of “fuzziness” in the measures of word length and relative position of the at least one graphical feature that is used.

Generally, there may be false positives (incorrectly identified features) and false negatives (missed features) in the word analysis. This is especially true if less certain features (e.g. bows and vertical periods) are used. In this case a sort of “fuzzy” logic can be applied; the match between the accepted words in the dictionary and the word under analysis need not be complete. There might also be a situation wherein detection of one or more features has a known uncertainty. This might be quantified in a fuzzy logical value between 0 and 1, or just as a general uncertainty. With reference to FIG. 5, a fuzzy region is identified for an ascender.

According to an aspect of the present invention, a selected dictionary word should have:
All the features from the unrecognized word that is classified as certain (probability 1).
No “certain” features (probability 0) that is not present in the unrecognized word.
At least a predefined score of fuzzy features are fulfilled. This could be a simple n out of m rule that is general dependent on the number of fuzzy features.

According to an example of embodiment of the present invention, a merit function can be calculated as:

$$Ψ = \frac{{\prod }_{i = 1}^{n} ( 1 - {p}_{i} ) \cdot {\prod }_{i = 1}^{k} {p}_{i}^{′}}{{\prod }_{i = 1}^{n} {p}_{i} \cdot {\prod }_{i = 1}^{k} ( 1 - {p}_{i}^{′} )}$$

where pᵢ are the probabilities of a features being present (i.e. has a probability ≧0.5) in the unrecognized word and not in the dictionary word, and p′ᵢ are the probabilities of the features being present in the dictionary word and not in the unrecognized word. The number of features missing, n, and the number of extra features, k, can both be zero, but if both are zero, there are no mismatch features.

The merit function Ψ has a value between 0 and 1. If any unrecognized words has features with a probability of one (is certain) or any missing feature that has a probability of 0 (is certainly missed in the sample word) the merit function is 0. I.e. the first two rules are included in the merit function. The other extreme value of Ψ,1, occurs when all features that differ have probability 0.5, i.e. are completely undecided. A higher value of the merit function gives a better match between the unrecognized word and the dictionary word.

According to an example of embodiment of the present invention, a dictionary word is accepted if the merit function is above a preset threshold.

All accepted words may then sorted and listed in linked lists according to the examples of embodiments of the present invention as outlined above.

According to another aspect of the present invention, when the unrecognized words provides an output from the dictionary, the dictionary look up process may comprise returning a measure of similarity according to a similarity measure as known to a person skilled in the art (for example a measure of correlation) between the unrecognized words and each word that is output from the dictionary for this particular unrecognized word.

According to another example of embodiment of the present invention, wherein a situation when the dictionary look up process returns more than one candidate word as the identification of the unrecognized word, or the measure of similarity is inconclusive, at least one other geometrical feature is being identified in the unrecognized word and used when indexing the dictionary before being used in the look up process. If the result of the dictionary look up process using this alternative geometrical feature provides fewer candidate words as identification of the unrecognized word, this result is kept for further processing in the OCR system. Otherwise, the first result provided for by the first identified geometrical feature is kept for further processing in the OCR system.

According to another example of embodiment of the present invention, when the dictionary look up process returns a number of candidate words above a preset threshold level, the dictionary look up process is repeated iteratively, wherein each next iteration step comprises identifying one more additional relative measure of position for another graphical feature in the unrecognized word in addition to other geometrical features identified in previous iteration steps, and then indexing the dictionary according to the index identified in this iterative step before performing the dictionary look up process, continuing performing the iterations until the number of candidate words that are returned from the dictionary look up process is below the preset threshold level, or there are no more graphical features to identify in the unrecognized word, which ever occurs first.

In this disclosure the term “geometric feature” comprises any graphical image element providing a distinctive stamp of appearance of the text in an image of a document, not only shape components as described above, but also any graphical appearance that provides distinct stamps of textual elements in a document.

1. A method for a dictionary look up process in an Optical Character Recognition (OCR) system, wherein the method comprises the steps of
providing an analysis of unrecognized words from a document being processed in the OCR system comprising identifying a number of pixels constituting word length and a relative measure of position within each respective unrecognized word of at least one identified or selected graphical feature related to characters constituting the unrecognized word,
analyzing words comprised in the dictionary providing a number of pixels constituting word length, and a relative measure of position within each respective word of the at least one identified or selected geometrical feature related to characters constituting each respective word,
organizing the dictionary as a look up dictionary indexed by the respective number of pixels constituting the word length and the respective corresponding relative measure of position of the at least one identified or selected geometrical feature within each of the respective words,
using the measures of the number of pixels constituting the word length for each respective unrecognized word and the relative measure of the position within each respective unrecognized word in the look up process in the dictionary.

2. The method according to claim 1, wherein the look up process returns one or more candidate words as an identification of the respective unrecognized word, or separately or in addition to the candidate words, a measure of similarity between each respective unrecognized word and each respective candidate word that is returned.

3. The method according to claim 2, wherein a situation when the look up process returns more than one candidate word as the identification of the unrecognized word, or the measure of similarity is inconclusive, at least one other geometrical feature is being identified in the unrecognized word and used when indexing the dictionary before being used in the look up process.

4. The method according to claim 2, wherein a situation when the dictionary look up process returns a number of candidate words above a preset threshold level, the dictionary look up process is repeated iteratively, wherein each next iteration step comprises identifying one more additional relative measure of position for another graphical feature in the unrecognized word in addition to other geometrical features identified in previous iteration steps, and then indexing the dictionary according to the index identified in this iterative step before performing the dictionary look up process, continuing performing the iterations until the number of candidate words that are returned from the dictionary look up process is below the preset threshold level, or there are no more graphical features to identify in the unrecognized word, which ever occurs first.

5. The method according to claim 1, wherein the step of organizing the dictionary comprises indexing the dictionary only according to the measure of the word length for each respective word, and whenever an unrecognized word is used in the look up process, all words having the same word length is analyzed with respect to the relative measure of position for the at least one graphical feature before being compared with the unrecognized word providing the list of candidate words.

6. The method according to claim 1, wherein the identified or selected geometrical feature is one of a shape component out of a fixed number of different shape components.

7. The method according to claim 6, wherein each respective word in the dictionary is linked to a database comprising references to the shape components of each character constituting the respective words, and the sequence of the referenced shape components details the interconnection between the shape components.

8. The method according to claim 1, wherein the step of providing an analysis of unrecognized words comprises identifying a selected geometrical feature or shape component from connected pixels in images of words from the document being processed in the OCR system.

9. The method according to claim 8, wherein each respective word in the dictionary is linked to a database comprising linked lists of images of character constituting the respective words, wherein there is a linked list for each respective font type identified in the image of the document being processed in the OCR system.

10. The method according to claim 9, wherein the linked lists comprises images of characters of the respective font type comprises images of the respective characters in different sizes.

11. The method according to claim 1, wherein the measure of word length for a word with n characters is calculated as
$$W = {\sum }_{i = 1}^{n} w ( class ( {ch}_{i} ) ) + ( n - 1 ) δ$$
wherein class(chᵢ) is the character class for the character in position i of the word, w( . . . ) is the width of the character in the class and δ is the character-to-character distance for characters within the word.

12. The method according to claim 1, wherein the relative measure of position for the graphical feature is calculated as
$${AD}_{pos} = {\sum }_{i = 1}^{k} w ( class ( {ch}_{i} ) ) + ( k - 1 ) δ + {p}_{k}$$
wherein pₖ is the position or pixel number of the graphical feature, class(chᵢ) is the character class for the character in position i of the word, w( . . . ) is the width of the character in the class and δ is the character-to-character distance for characters within the word.

13. The method according to claim 1, wherein a tolerance for the relative measure of position for a geometrical feature within an unrecognized word is calculated as
$${range}_{AD 1} = 〈 {\sum }_{i = 1}^{k - 1} w ( class ( {ch}_{i} ) ) + max ( k - 1 , 0 ) δ - {Δ}_{1} , {\sum }_{i = 1}^{k} w ( class ( {ch}_{i} ) ) + max ( k - 1 , 0 ) δ + {Δ}_{1} 〉$$
wherein class(chᵢ) is the character class or font type for the character in position i of the word, w( . . . ) is the width of the character in the class and δ is the character-to-character distance, and Δ₁ is a tolerance variation associated with the position of the graphical feature.

14. The method according to claim 1, wherein a tolerance for the position of a character within a word is calculated as:
$${range}_{AD 2} = {\sum }_{i = 1}^{k - 1} w ( class ( {ch}_{i} ) ) + max ( k - 1 , 0 ) δ + {p}_{k} + 〈 - {Δ}_{2} , + {Δ}_{2} 〉$$
wherein class(chᵢ) is the character class or font type for the character in position i of the word, w( . . . ) is the width of the character in the class and δ is the character-to-character distance, and Δ₂ is a tolerance variation associated with the position of the character.

15. The method according to claim 1, wherein the dictionary look up process comprises measuring a merit function defined by
$$Ψ = \frac{{\prod }_{i = 1}^{n} ( 1 - {p}_{i} ) \cdot {\prod }_{i = 1}^{k} {p}_{i}^{′}}{{\prod }_{i = 1}^{n} {p}_{i} \cdot {\prod }_{i = 1}^{k} ( 1 - {p}_{i}^{′} )}$$
wherein pᵢ are the probabilities of a features being present in the unrecognized word and not in the dictionary word, and p′ᵢ are the probabilities of the features being present in the dictionary word and not in the unrecognized word.
